(19) United States
(12) Patent Application Publication
(10) Pub. No.: US 2017/0053201 A1
(43) Pub. Date: Feb. 23, 2017

(54) MEMORY ELEMENT FOR A NEURAL NETWORK

(71) Applicant: Georges Harik, Palo Alto, CA (US)

(72) Inventor: Georges Harik, Palo Alto, CA (US)

(21) Appl. No.: 15/224,305

(22) Filed: Jul. 29, 2016

Related U.S. Application Data
(60) Provisional application No. 62/203,606, filed on Aug. 11, 2015.

(51) Int. Cl. G06N 3/08; G06F 12/02

(52) U.S. Cl. CPC G06N 3/08; G06F 12/023; G06F 2212/251

(57) ABSTRACT

A system includes a number of different long short term memory (LSTM) elements, in which the input value of each LSTM element is gated by a different number of input control signals. In addition, each LSTM element may also include a state feed-back path in which the current state is weighted by a function of a product of one or more memory control values.

### CROSS REFERENCE TO RELATED APPLICATION

The present application claims priority from U.S. Provisional Patent Application Ser. No. 62/203,606, filed on Aug. 11, 2015. The application is hereby incorporated by reference herein in its entirety

### BACKGROUND OF THE INVENTION

1. Field of the Invention

Programs incorporating machine learning techniques are widely used in many applications today. Many learning programs are implemented on neural network platforms. Even though the state of the art has advanced rapidly in recent years, many difficulties remain. For example, recurrent neural networks, which are neural networks specialized with sequential data, have been among the most difficult to train. One reason for the difficulty is that such a network iterates a large number of times through its internal states during training, with each iteration a likelihood of “blowing up” or reducing to insignificance either an internal state or its derivative.

One particular kind of network, referred to as the Long Short Term Memory (LSTM) neural network, is designed to mitigate these problems by providing control signals to gate interactions with an internal memory state. LSTM is first described in the article “Long Short-Term Memory,” by S. Hochreiter and J. Schmidhuber. A copy of the article may be obtained at http://deeplearning.cs.cmu.edu/pdfs/Hochreiter97_lstm.pdf. In an LSTM element, the control signals limit when the memory element may be written into and read from, while maintaining a connection between successive memory states, thereby retaining memory.

FIG. 1 shows schematically LSTM element 100, which is used in an LSTM neural network. As shown in FIG. 1, LSTM element 100 includes internal state element 101, which value s[n] is fed back to multiplicative element 108. Multiplicative element 108 multiplies state value s[n] with (1−p), where p is the value of control signal cᵣ[n] received from memory control node 109. For a small p (e.g., p approximately zero), the next state s[n+1] for state element 101 has a large contribution from current state s[n]. For a larger p (e.g., p approximates 1), next state s[n+1] has a greater contribution from the value of the signal received from multiplicative element 102. Multiplicative element 102 multiplies control signal cᵢ[n] received from input control node 103 and input signal i[n] received from input node 104 to provide an input value to state element 101. Based on the value from multiplicative element 102 and multiplicative element 108, state element 101 determines the next state s[n+1]. The next state value s[n+1] of internal state element 101 is multiplied to control signal c₀[n] from output control node 106 by multiplicative element 105 to provide output value y[n +1], Memory control node 109, input control node 103, input node 104 and output control node 106 are typically neurons in the neural network, each providing as output a value between 0.0 and 1.0, with an expected value of 0.5. Each such neuron receives one or more input signals and implements a non-linear function of the input signals and one or more trained parameter values. In many neural network implementations, a neuron implements a logistic or sigmoidal function of a weighted sum of its input, with the weights being the trained parameter values.

LSTM neural networks have been among the most successful networks that deal with sequential data. Additional information regarding LSTM neural network, expressed in lay terms, may be found, for example, in the article “Demystifying LSTM Neural Networks,” available at: http://blog.teminal.com/demistifying-long-short-term-memory-lstm-recurrent-neural-networks/.

### SUMMARY

According to one embodiment of the present invention, an LSTM element includes (a) a first multiplicative element that receives an input value and more than one input control value provides a resulting input value that is a function of a product of the input value and all the input control values; (b) a state element providing a state value at each time point, wherein the state value assumes a first value at a first time point, and assumes a second value at a second time point immediately following the first time point, the second value being derived from a sum of the resulting input value and a function of the first value; and (c) a second multiplicative element that receives the state value of the state element and an output control value, and provides an output value as a function of a product of the state value and the output control value.

In addition, in one embodiment of the present invention, the LSTM memory element further includes a third multiplicative element that receives one or more memory control values to provide a feedback state value that is a function of the current state value and the memory control values, such as one less the product of the one or more memory control values. The number of memory control values is preferably greater than one.

According to one embodiment of the present invention, a system includes a number of different LSTM elements, wherein the input value of each LSTM element is gated by a different number of input control signals.

The present invention is better understood upon consideration of the detailed description below in conjunction with the accompanying drawings.

### BRIEF DESCRIPTION OF THE DRAWINGS

FIG. 1 shows schematically LSTM element 100, which is used in an LSTM neural network.

FIG. 2 shows schematically LSTM element 200, in which multiplicative elements 202 and 209 each receive more than one control signals that gate the input value, in accordance with one embodiment of the present invention.

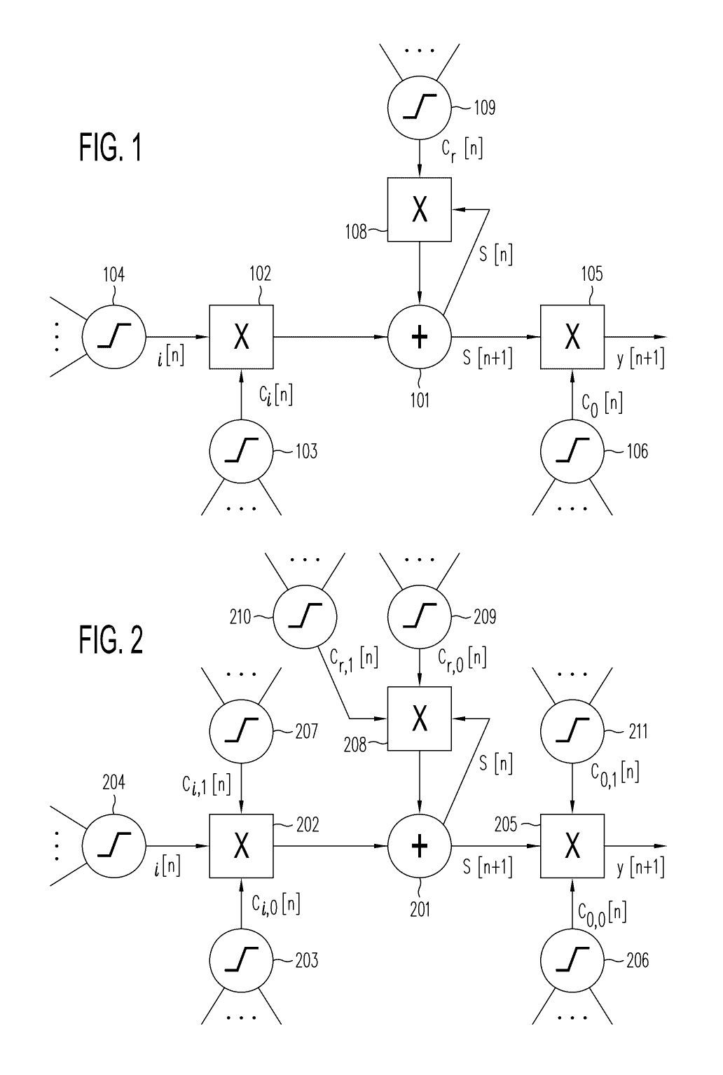

### DETAILED DESCRIPTION OF THE PREFERRED EMBODIMENTS

The present inventor discovered that, by adding one or more additional control signals to gate the input signal in some or all of the LSTM elements of an LSTM neural network, the performance of the LSTM neural network can be profoundly improved. FIG. 2 illustrates this approach, showing schematically LSTM element 200, in which multiplicative elements 202, 205 and 208 each receive more than one control signals that gate the respective input value, memory state value and output value, in accordance with one embodiment of the present invention.

As shown in FIG. 2, LSTM element 200 includes internal state element 201, which current state value s[n] is fed back to multiplicative element 208. Multiplicative element 208 multiplies state value s[n] with (1−p), where p is the product of control signals c_{r,0}[n] and C_{r,1}[n], received from first memory control node 209 and second memory control node 210. In one implementation, the next state s[n+1] is the weighted sum of the previous state s[n](weighted by 1−p) and the value of the signal received from multiplicative element 202. For a small p (e.g., p approximately zero), the next state s[n+1] has a large contribution from current state s[n]. For a larger p (e.g., p approximates 1), next state s[n+1] has a large contribution from the value of the signal received from multiplicative element 202. Multiplicative element 202 multiplies control signal c_{i,0}[n] received from first input control node 203, control signal c_{i,1}[n] from second input control node 207, and input signal i[n] received from input node 204. Based on the value from multiplicative element 202 and multiplicative element 208, state element 201 determines the next state s[n+1]. The next state s[n+1] of internal state element 201 is multiplied to first output control signal c_{0,0}[n] and second output control signal c_{0,1}[n] from output control nodes 206 and 211, respectively, by multiplicative element 205 to provide output value y[n+1].

First and second memory control nodes 209 and 210, first and second input control node 203 and 207, input node 204 and first and second output control nodes 206 and 211 may be conventionally implemented neurons in a neural network. Although shown in FIG. 2 with signals from only first input control node 203 and second input control node 207, any number of input control signals from corresponding additional input control nodes may be included as input signals to multiplicative element 202. Likewise, any number of memory control signals from corresponding additional memory control nodes may be included as input signals to multiplicative element 208, and any number of additional output control signals may be included as input signals to multiplicative element 205. Some or all of the additional control signals may be trained to have a value close to or equal to ‘1’, so that the effect number of control signals at each multiplicative element may be varied as required.

The present inventor's discovery is unexpected and surprising, as the conventional theory would lead one to believe that, in an LSTM network, additional control signals to gate the input signal of an LSTM element should make no difference in the performance of the resulting LSTM neural network. Nevertheless, the present inventor has demonstrated the unexpected result in an experiment involving sentence completion. In a sentence completion program, through training, the program learns to predict the words in the remainder of a sentence based on a fragment of the sentence. For example, given the fragment “Where is New York”, the program is expected after training to provide possible candidates for the complete sentence, such as “Where is New York University?” “Where is New York Yankee Stadium?” and so forth. In the prior art, less favorable results are obtained when the program is trained with the sentence fragment being seen as a collection of characters than a collection of words. Also, in the prior art, more favorable results are obtained when the training data are provided from a collection of documents that are all of the same language. However, a search program trained in this manner would perform unfavorably when required to search over a collection of documents that include documents of a number of different languages. Consequently, many applications are artificially limited as to be language-specific. By introducing the LSTM elements of the present invention, the present inventor was able to show not only performance improvement in the word-based approach, but also showed no significant performance difference between the word-based approach and the character-based approach. This result provides significant promise for many applications that can be used across language boundaries, for example.

The present inventor theorizes that, in practice, multiple control lines are better at retaining information than one. As the number of control lines becomes arbitrarily large, the LSTM of the present invention tends to a limit that is similar to a conventional computer memory bank, in that that the control lines play the role of the memory address lines. By providing different types of LSTM elements of the present invention in an LSTM network, with each type of LSTM element having a different number of control lines to gate the respective input signals, one may allow a multitude of different memories to co-exist, thereby enabling different memory characteristics to exist in the system. One implementation may also include conventional neurons that are without memory protection. A system providing different types of LSTM elements may be referred to as “Higher Order LSTM.” Such a system has been shown to be particularly effective in training programs in the applications described above.

The above detailed description is provided to illustrate specific embodiments of the present invention without being limiting. Various modification and variations within the scope of the present invention are possible. The present invention is set forth in the accompanying claims.

I claim:

1. A memory element receiving an input value and providing an output value, comprising:
a first multiplicative element receiving the input value, a plurality of input control values and providing a resulting input value that is a function of a product of the input value and the input control values;
a state element providing a state value at each time point, wherein the state value assumes a first value at a first time point, and assumes a second value at a second time point immediately following the first time point, the second value being derived from a sum of the resulting input value and a function of the first value; and
a second multiplicative element receiving the state value of the state element and a third control value, and providing the output value as a function of a product of the state value and the third control value.

2. The memory element of claim 1, further comprising a third multiplicative element receiving the first value and one or more memory control values, wherein the third multiplicative element multiplies the first value to a function of the product of the memory control values.

3. The memory element of claim 2, wherein the function of the product of the one or more memory control values being one less the product of the memory control values.

4. The memory element of claim 1, wherein the second multiplicative element further receives a fourth control value, wherein the output value is also a function of a product of the input value, the third control value and the fourth control value.

5. A system comprising a first memory element and a second memory element, wherein the first memory element and the second memory element comprise:
a first multiplicative element receiving the input value, a number of input control values and providing a resulting input value that is a function of a product of the input value and the input control values;
a state element providing a state value at each time point, wherein the state value assumes a first value at a first time point, and assumes a second value at a second time point immediately following the first time point, the second value being derived from a sum of the resulting input value and a function of the first value; and
a second multiplicative element receiving the state value of the state element and an output control value, and providing the output value as a function of a product of the state value and the output control value, and wherein the number of input control values in the first memory element is different from the number of input control values in the second memory element.
